(19) United States
(12) Patent Application Publication
(10) Pub. No.: US 2006/0250976 A1
(43) Pub. Date: Nov. 9, 2006

(54) Method and apparatus for media device correspondence

(75) Inventors: Daniel G. Wing, San Jose, CA (US); Kelly Muniz, Morgan Hill, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/103,822

(22) Filed: Apr. 12, 2005

(51) Int. Cl. H04L 12/26

(52) U.S. Cl. 370/252

(57) ABSTRACT

A system and method provide for managing media device correspondence that may be used in conjunction with a media application for transferring mixed media to/from the devices in an independent, coordinated or synchronized manner. Embodiments provide for determining a correspondence availability, establishing a correspondence relating to the correspondence availability and/or destroying or otherwise modifying a correspondence availability or correspondence. In one more specific embodiment, media device correspondence is provided in conjunction with a non-voice media device and a voice media device.

### BACKGROUND OF THE INVENTION

1. Field of Invention

The present invention relates in general to the field of networking and more specifically to systems and methods for enabling more than one media device to be used in conducting communications or other user interactions.

2. Description of the Background Art

Great strides have been made in integrating voice and data communications. For example, the advent of private branch exchanges or PBXs provided automated routing and switching. Pulse code modulation or PCM (1960s) further enabled binary voice transmission, and time division multiplexing or TDM (1980s) enabled digital voice channel aggregation. Asynchronous Transfer Mode or ATM (early 1990s) provided low delay packetized voice switching with combinable media. And Voice Over Internet Protocol (VOIP) enables voice-data convergence with a promise for low cost, advanced multimedia communications.

Current voice-data communication solutions may nevertheless present problems. For example, when performing a videoconference that consists of both video and audio, current solutions typically require a PC, PDA or other video device and an IP-phone to be directly connected to each other as well as to IP network ports. In such current systems, the audio cannot be performed using conventional telephones, cell phones and the like. Users must instead be in close proximity to their PC and IP phone connection points. Users must also manually identify the video and audio devices to the network components using an identifier such as the media access control (MAC) address or IP address. To make matters more difficult, MAC addresses do not traverse L3 boundaries and IP addresses may change due to the use of Dynamic Host Configuration Protocol (DHCP) for assigning IP addresses.

An alternative voice-data solution avoids the repetitive device setup of multiple IP devices of the above IP device pair by instead using a single PC or other integrated device. However, such a solution nevertheless suffers from many of the same local per-session setup, connection and single protocol problems as with other voice-data solutions.

Accordingly, there is a need for a mechanism that enables the above and/or avoids other problems of existing media communication systems.

### SUMMARY OF EMBODIMENTS OF THE INVENTION

Embodiments of the present invention provide a system and method for managing media device correspondence that avoid problems encountered with conventional mixed media solutions. Various embodiments provide for remote determination of available correspondences (correspondence availabilities) of a wide variety of IP and/or non-IP devices or portions thereof for conducting mixed media sessions, such as those including voice and non-voice media. Correspondence availabilities may further be modified, destroyed or extended to include an established correspondence of such devices, and may remain active for use in a current and/or later media session. Embodiments also enable such media device correspondences to be used in an otherwise conventional manner for providing independent, coordinated or synchronized transfer or presentation of voice and non-voice media, or to conduct correspondence operations in accordance with user, media device or media application criteria.

### BRIEF DESCRIPTION OF THE DRAWINGS

FIG. 1 is a flow diagram illustrating a media device correspondence system according to an embodiment of the invention;

FIG. 2a is a flow diagram illustrating a per session indicator based operation of the media device correspondence system of FIG. 1 according to an embodiment of the invention;

FIG. 2b is a flow diagram illustrating a re-useable indicator based of the media device correspondence system of FIG. 1 according to an embodiment of the invention;

FIG. 3 is a schematic diagram illustrating an exemplary computing system including one or more of the components of FIG. 1, according to an embodiment of the invention;

FIG. 4a is a flow diagram illustrating a correspondence manager according to an embodiment of the invention.

FIG. 4b is a flow diagram illustrating a media transfer controller according to an embodiment of the invention;

FIG. 4c illustrates an example of a correspondence table useable by a correspondence system or other network component according to an embodiment of the invention;

FIG. 4d illustrates an example of a further correspondence table useable by a correspondence system or other network component according to an embodiment of the invention.

FIG. 5a is a flowchart illustrating a correspondence availability method employing a per session correspondence indicator according to an embodiment of the invention;

FIG. 5b is a flowchart illustrating a correspondence establishing method employing a per session correspondence indicator according to an embodiment of the invention;

FIG. 6a is a flowchart illustrating a correspondence availability method employing a predetermined correspondence indicator according to an embodiment of the invention;

FIG. 6b is a flowchart illustrating a correspondence establishing method employing a predetermined correspondence indicator, according to an embodiment of the invention; and

FIG. 7 is a flowchart illustrating a correspondence destroying method according to an embodiment of the invention.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer” for purposes of embodiments of the present invention may include any processor-containing device, such as a mainframe computer, personal computer, laptop, notebook, microcomputer, server, personal data manager or “PIM” (also referred to as a personal information manager or “PIM”) smart cellular or other phone, so-called smart card, settop box or any of the like. A “computer program” may include any suitable locally or remotely executable program or sequence of coded instructions which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for synchronously presenting multiple video program ID streams, such as on a display screen of the computer, the computer would have suitable instructions (e.g., source code) for allowing a user to synchronously display multiple video program ID streams in accordance with the embodiments of the present invention. Similarly, if a computer is employed for presenting other media via a suitable directly or indirectly coupled input/output (I/O) device, the computer would have suitable instructions for allowing a user to input or output (e.g., present) program code and/or data information respectively in accordance with the embodiments of the present invention.

A “computer-readable medium” for purposes of embodiments of the present invention may be any medium that can contain, store, communicate, propagate, or transport the computer program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. The computer readable medium may have suitable instructions for synchronously presenting multiple video program ID streams, such as on a display screen, or for providing for input or presenting in accordance with various embodiments of the present invention.

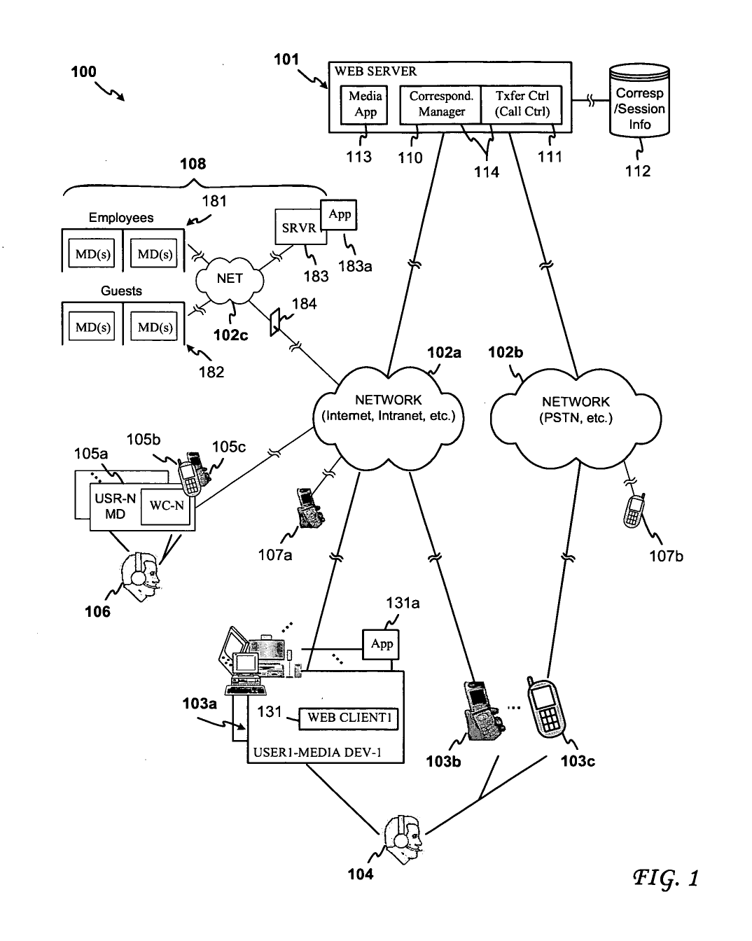

Referring now to FIG. 1, there is seen a flow diagram illustrating a correspondence enabled network system 100 according to an embodiment of the invention. Network system 100 includes service host 101, networks 102a-c, media devices 103a-c of a first user 104, media devices 105a-c of a second user 106 and other media devices 107a-d of other users (not shown). Network system 100 also includes internetwork 108. Internetwork 108 may, for example, correspond with service host 101, networks 102a-b and media devices 103a-c, 105a-c, or may comprise a further internetwork of media devices that is operable independently or in conjunction therewith (e.g., providing for more centralized or distributed correspondence or media applications), in accordance with the requirements of a particular application.

Network system 100 broadly provides for enabling one or more media device users to conduct one or more of calling, conferencing or other substantially any other media applications, which applications may further include a corresponding transferring or presenting of voice-media or other media type combinations. The media application may be conducted in a substantially independent manner by the media devices, or may be facilitated by a server or other remote computing system, and may be conducted in an otherwise conventional manner not inconsistent with the discussion herein. The media may, for example, include independently provided, coordinated or synchronized voice media and non-voice media (e.g., text, graphics, animation, audio, video, controls, and so on), and such providing, coordinating or synchronizing may be conducted in an otherwise conventional manner consistent with the discussion herein.

Note that the term “or” as used herein is intended to include “and/or” unless otherwise indicated or unless the context clearly dictates otherwise. The term “portion” as used herein is further intended to include “in whole or contiguous or non-contiguous part” which part can include zero or more portion members, unless otherwise indicated or unless the context clearly dictates otherwise.

Within system 100, media device correspondence system 114 provides for managing one or more correspondences of media devices, links, users, and so on, or portions thereof that may then be included in a current or later media session. The illustrated media device correspondence system (correspondence system) more specifically provides for determining correspondence availabilities, establishing correspondences relating to the availabilities, and destroying or otherwise modifying correspondences/availabilities. The correspondence system may further be configurable for inter-operating with or otherwise facilitating various network or media session operations that may be conducted. Such operations may, for example, include but are not limited to causing media to be transferred/received by corresponding ones of available media devices according to active correspondences, facilitating media device/user security or media session operations, responding to network, media session or correspondence management related criteria, and so on, or some combination.

One correspondence system embodiment provides for determining a correspondence availability between two or more media transferring/presenting or “media handling” devices. Correspondence availabilities of one or more sets of media devices or other correspondences may also be extended from including the media device to including one or more other media devices, and may further be established, utilized, destroyed or otherwise modified.

In a more specific embodiment, the correspondence system determines a correspondence availability of a media device that is indicated as handling non-voice media (non-voice media device). The correspondence availability may remain active and unused, used at a later time or intermittently with other users, devices or correspondences/availabilities, or used in conjunction with intermittently coupled media devices. An active correspondence availability may further be extended as an established correspondence between non-voice media device and a media device that is indicated as handling voice media (voice media device), or may be destroyed or otherwise modified. A correspondence availability may also be determined with respect to a voice media device and extended to a non-voice device, used with other media combinations, and so on, in accordance with the requirements of a particular application.

The correspondence availability may, for example, include at least one correspondence indicator indicating a raw correspondence availability (e.g., a voice media device phone number, user/device ID or other correspondence identifier), or further indicate or associate other criteria. Such other criteria may, for example, include user, media device or network operating parameters, device/user relationship, priority, capabilities, or other media application parameters, or availability, establishing, destroying or other correspondence parameters, or some combination thereof (Criteria may, for example, be determined in an otherwise conventional manner for transferring information among system 100 components. A suitable push, pull or other transfer mechanism may, for example, be employed. Criteria may also be stored/retrieved from one or more stored or “predetermined” criteria sets, or some combination of mechanisms may be used.

A further correspondence system embodiment provides for establishing a correspondence relating to a correspondence availability. The correspondence system may establish a correspondence at the system's own initiation or responsive to a media device, media application or user request, or other time/event condition(s). The correspondence system may, for example, respond to a media device request by establishing a media device or media device link correspondence. Once established, the correspondence may be used, for example, by a controlling media application (e.g., one or more of 113, 183a or 131a) for enabling independent, coordinated or synchronized transfer of non-voice media to/from a non-voice media device and voice media to/from a voice media device.

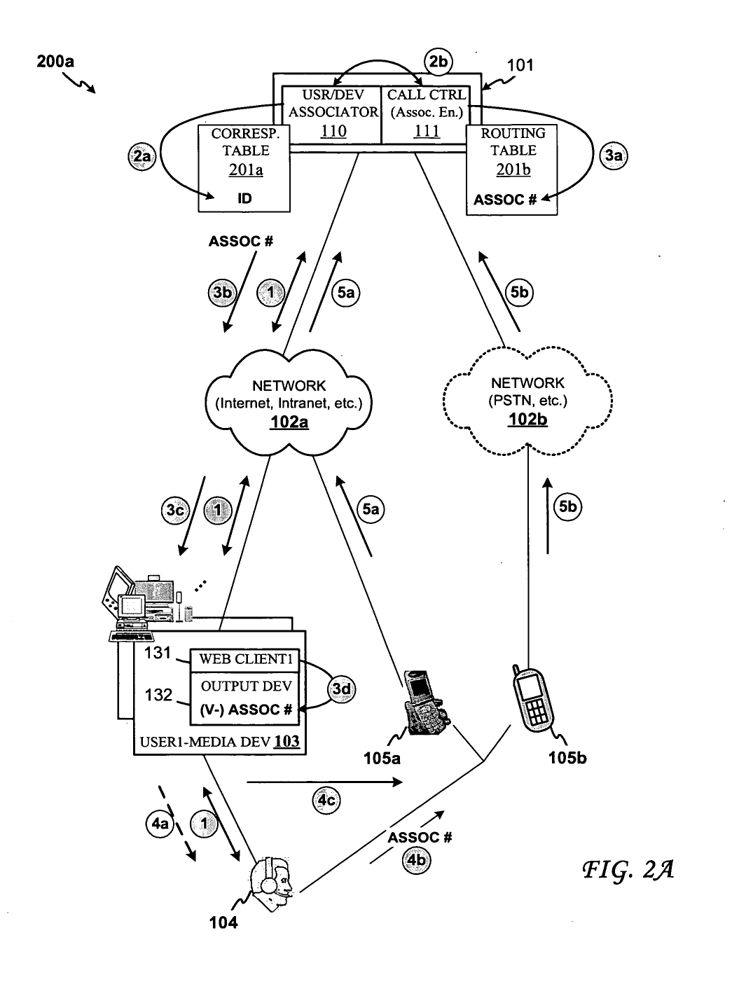

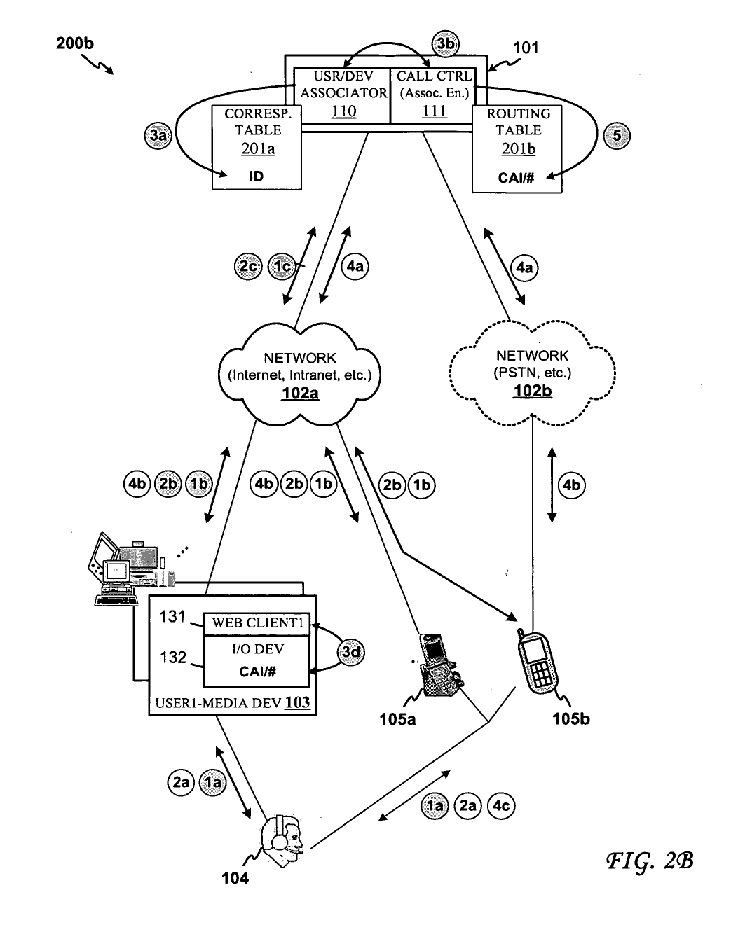

Note, however, that a correspondence availability may be managed substantially independently from an associated correspondence or extended media device coupling or communication link. For example, a correspondence availability may be determined before an associated correspondence is established or persist if no associated correspondence is established or after an established correspondence is destroyed. Failure to establish or termination of an associated correspondence may, for example, occur where a media device is or becomes unavailable, inoperative, uncoupled or otherwise disconnected from a media session, or where an associated correspondence availability or correspondence is destroyed, disallowed for a particular user, device, correspondence and so on, or otherwise rendered inactive. (See, for example, FIGS. 2a and 2b.)

A further correspondence system embodiment provides for destroying a media device correspondence or correspondence availability. Various embodiments may, for example, provide for conducting such destroying in response to one or more of user requests, timeout periods and specifiable events. Such correspondence destroying criteria may, for example include but is not limited to: after a current, later or concluded visitor/guest use of a connection, at the end of a media session or workday, in conjunction with user checkout/disconnect from a system or building, receipt of an indicator from a controlling or otherwise corresponding media application, and so on, among other combinable alternatives. (It will be appreciated, for example, that a system checkout, user/device exiting a building, and so on, are detectable and reportable events that may be communicated in an otherwise conventional manner to one or more receiving systems, which systems may include a correspondence system.) Within system 100, service host 101 may, for example, include a Web server, application/communication server or other network component that is at least intermittently communicatively couplable with two or more media devices for conducting media device correspondence and for hosting a correspondence system. Service host 101 may further provide for hosting a media application (e.g., 113), or further, for conducting one or more media sessions. Service host 101 may, for example, be coupled via network 102a to media device 103a (e.g., a PC, PDA, settop box or game console) of user 104, via network 102a to media device 103b (e.g., an IP phone) and via one or more of networks 102a and 102b to media device 103c of user 104 (e.g., a cell phone). Alternatively, one or more of these or other media devices may become coupled to service host 101 in conjunction with conducting media device correspondence or a media session. Service host 101 includes correspondence manager 110, correspondence enabled media transfer link controller (link controller) 111, storage 112 and media application 113.

Correspondence manager 110 provides for responding to a user, media device or media application by setting or modifying correspondence management parameters, or by conducting media device correspondence operation, and is operable alone or in conjunction with link controller 111 or media application 113. More specifically, correspondence manager 110 provides, during correspondence setup operations, for conducting correspondence system initialization, responding to a media device or media application by initiating correspondence availability determining or responding to a media device, user or media application by conducting correspondence availability or correspondence modification. In one embodiment, correspondence manager 110 further provides for conducting transfer of non-voice media to a non-voice media device and invoking link controller 111 for conducting transfer of voice media to a voice media device. In another embodiment, one or more established correspondences may be transferred by correspondence manager 110 to one or more other system 100 components (e.g., a correspondence list) for conducting such transfer, among other combinable alternatives.

Link controller 111 provides for correspondence-enabled linking of media devices or routing of related media to/from such devices. Link controller 111 of the present embodiment more specifically includes a correspondence enabled call controller. As with conventional call control, link controller 111 is configurable for receiving and responding to an IP phone call initiation via a suitable IP network (e.g., network 102a or 102c), and may control or facilitate such calls in an otherwise conventional manner. A “call” may further include multimedia information that is provided in a substantially independent, coordinated or synchronized manner with other media or media types.

Link controller 111, however, differs from conventional control in various ways. For example, link controller 111 does not require a direct connection between corresponding devices (e.g., a non-voice media device and a voice media device), and may utilize media device correspondence alone or in conjunction therewith. Link controller 111 also provides for call control in conjunction with non-IP media devices, or further, by facilitating media device correspondence in conjunction with such devices or combinations of IP and non-IP devices. Such devices may, for example, presently include one or more of conventional wired/wireless, cellular and satellite phones, which communication devices may further operate over one or more of networks 102a-c.

In one embodiment, call controller 111 is operable responsive to a call initiated by a media device via PSTN network 102b for providing a correspondence availability or correspondence, or for controlling or otherwise facilitating the call. Such conducting may, for example, include transferring voice media to/from a voice media device (e.g., 103b) via network 102a or transferring voice media to/from the voice handling media device 103c via network 102b. As with IP calling, link controller 111 further provides for transferring such media in an independent, coordinated or synchronized manner in an otherwise conventional manner in accordance with the requirements of a particular application.

Correspondence/service storage 112 provides for storing the aforementioned correspondence or other correspondence system 114 parameters. Correspondence/service storage 112 may further provide for storing program code or other information in conjunction with media application 113 operation.

Networks 102a-c may generally include suitable physical or virtual LANs, WANs or other fixed or reconfigurable networks in accordance with the requirements of a particular application. Network 102a may more specifically include a digital media network, such as an IP protocol wide area network (e.g., the Internet), and network 102b may include a non-IP protocol network such as a Public Switched Telephone Network (PSTN).

Media devices 103a, 105a may generally include one or more of PCs, laptops, PDAs, game consoles, network controllers/expanders, so-called smart phones, or substantially any other computing system(s) that are capable of coupling to a remote service host and conducting the transfer or presentation of at least non-voice media. Media devices 103a, 105a are more specifically illustrative of non-voice media devices for purposes of the present example, so that operations of such devices may be distinguishable from those of other media devices. Media devices 103b-c, 105b-c may generally include the same devices as with media devices 103a, 105a, but are more specifically referenced herein as being illustrative of IP phones or other similarly configurable devices or portions thereof, and of conventional, cellular, satellite or other similarly configurable devices or portions thereof respectively.

Media devices 103b-c, 105b-c, for purposes of the present example, provide for the transfer or presentation of at least voice media via network 102a and network 102b respectively and are referred to herein as voice media devices. Media devices 107a-b may also generally include substantially the same devices as with media devices 103a-c, 105a-c, but are more specifically illustrative of voice media devices that are useable in conjunction with system 100 operation without the further use of non-voice media devices or visa versa. At least non-voice media devices 103a, 105a may, for example, include a browser, other Web client or other communication interface for transferring/presenting information in conjunction with correspondence or media application operations. (It will be appreciated that other media devices may also similarly include a browser, other Web client or other communication interface, as is becoming common in substantially all computing devices.)

Internetwork 108 may include one or more internetworks (e.g., a fixed or reconfigurable, e.g., virtual, local area or private network of a business concern) that may provide for locally hosted media device correspondence or that may utilize media device correspondence hosted by service host 101 in a similar manner as with networks 102a-b and user devices 103a-c and 105a-c. Internetwork 108 may, for example, include IP and non-IP networks/systems 102c, IP/non-IP media devices (e.g., employee stations 181 and guest stations 182) that may be coupled to such networks/systems, one or more servers 183.

Firewall 184 illustrates a wide variety of security mechanisms, such as firewalls, encryption, fire zone, compression, secure connections, and so on, one or more of which may be used in conjunction with various system 100 components. The use and placement of many such mechanisms are well known in the computer and networking arts, and various configurations of such mechanisms may be used in accordance with the requirements of a particular application.

FIGS. 2a and 2b illustrate exemplary media device correspondence operations that may utilize the network system 100 of FIG. 1. The FIG. 2a embodiment provides a variable or other per-request correspondence assignment, while the FIG. 2b embodiment provides for a fixed or reusable assignment. Various alternatives or combinations thereof will also become apparent to those skilled in the art. (Various system 100 components been removed for clarity's sake. However, references to internetworks including service host 101, networks 102a and 102b and media devices 103a-c may be applicable in substantially the same manner with regard to other media devices 107, internetwork 108 or other system 100 components, or a combination of such components, for example, as was already discussed.)

FIG. 2a illustrates how, in a per-request embodiment, one of media device 103a-c may couple to service host 101 via network 102a in an otherwise conventional manner (item 1). The media device, service host 101 or user 104 may further conduct identification, authentication or other security in conjunction with such coupling.

Correspondence operation may be initiated by one of media devices 103a-c coupling to correspondence manager 110 by initiating a preferably encrypted Web page or selecting a correspondence link, or upon correspondence manager 110 initiation. The media device coupling also identifies the media device to correspondence manager 110 according to a media device source identifier (e.g., IP address of a received packet). Correspondence manager 110 stores the source identifier in correspondence table 201a for later use in establishing a correspondence between the present media device and another media device (item 2a).

We will assume for purposes of the present example that media device 103a is an initiating media device. It will be appreciated, however, that media devices 103b-c (e.g., a PC, IP phone, cell phone and so on) may also be utilized in a similar manner.

Correspondence manager 110 further responds to correspondence initiation by invoking call controller 111 (item 2b). Call controller 111 responds by determining a correspondence availability indicator, which call controller 111 stores at least temporarily in routing table 201b and provides to correspondence manager 111 (item 3a). Correspondence manager 111 transfers the indicator, e.g., using the encrypted Web page, via network 102a to media device 103a, as indicated by items 3b-c. The correspondence availability indicator may, for example, include a unique dialable telephone number or another identifier useable for denoting a correspondence availability that may be extended as an association or correspondence with one or more other devices.

In one embodiment, media device 103a presents the correspondence availability indicator to user 104, for example, via the encrypted Web page (item 4a). User 104 may then extend the correspondence availability to another device, e.g., phones 103b or 103c, by dialing the unique dialable telephone number via a desired media device (item 4b). A PSTN-compatible phone user may instead dial a call controller access number and then enter presented the correspondence availability indicator, as indicated by item 5b. User entry may be conducted without user prompting, with interactive voice response (IVR), and so on, using a phone dial pad, speech recognition, other suitable mechanisms or some combination. (It will be appreciated that a wide variety of phones or other devices that are configurable for operating as such may be used, including but not limited to analog PBX, time division multiplexing, PBX or VoIP.)

In one alternative embodiment, system 200a provides for user 104 to respond to a correspondence availability indicator other than a telephone number by dialing a known or otherwise ascertainable telephone number and entering the correspondence availability indicator (with or without prompting). In another embodiment, media device 103a may utilize a Bluetooth, 802.x, infrared or other wired/wireless connection mechanism to establish a new connection or use an existing connection with one or more of devices 103b-c for transferring the correspondence availability indicator to such device. Media device 103a or the receiving media device may then automatically initiate a call to call controller, and user 104 or the indicator sending or receiving device may enter the correspondence availability indicator. Other embodiments of combinations thereof will also become apparent to those skilled in the art.

Call controller 111 responds to the media device call by comparing the unique dialable number or other correspondence availability indicator with those stored in routing table 210b. Call controller 111 may recognize a corresponding dialed number, for example, determined via ANI, as a correspondence route to media device 103b or 103c or reject a non-matching indicator (e.g., non-assigned, inactive, disallowed or destroyed), and may further provide a voice or other notification of the same to the calling media device or other system 200a devices.

Call controller 111 further provides for determining other media device information in accordance with an incoming call, correspondence availability indicator, and so on. If, for example, the call is a VoIP call, then call controller 111 may determine a specific identity of the calling media device. Such identity may, for example, include the media device IP address, hostname or other uniquely identifying information that may be provided via session initiation protocol (SIP), Skinny Client Control Protocol (SCCP, also referred to as Simple Client Control Protocol), H.323, media gateway control protocol (MGCP), H.248, and so on. If instead the call was over PSTN, then the call controller may, for example, determine information including the automatic number identification (ANI).

Call controller 111, may further associate the stored IP address or other media device identifier of media device 103a with the media device identity of media device 103b or 103c, thereby establishing a correspondence. Alternatively or in conjunction therewith, such identity may also be transferred to correspondence manager 110 or other system 200a component(s) for conducting such associating or other correspondence management, or further, for using such correspondence in conjunction with a media session.

Continuing now with FIG. 2b, the illustrated fixed or reusable association embodiment provides for a predetermined correspondence availability indicator that is provided to a user or media device prior to conducting correspondence operations. During such operations, one of any of media devices 103a through 103c may couple to service host 101 via network 102a as with the per request embodiment of FIG. 2a (items 1a-c). A coupling media device, service host 101 or user 104 may further conduct identification, authentication or other security in conjunction with such coupling. (We will again assume, for clarity's sake, that media device 103a couples with service host 101.)

Correspondence operation may be initiated via user/media device request, for example, by media device 103a initiating a preferably encrypted Web page, selecting a correspondence initiating link or upon correspondence manager 110 initiation. Such coupling again identifies media device 103a according to its source identifier (e.g., IP address included in a data packet). Correspondence manager 110 stores the source identifier in correspondence table 201a for later use in establishing a correspondence between the present media device and another media device (item 1d) or for conducting other correspondence management or media session operation.

Correspondence manager 110 further responds to correspondence initiation by requesting from media device 103a, via the encrypted Web page, a call number to which a desired voice-handling one of media devices 103b-c is coupled (items 2a-c). The call number is preferably provided by user 104 via media device 103a for greater security (item 2c), but may also be provided by media device 103a as with the embodiment of FIG. 2a (item 2a).

Correspondence manager 110 responds by invoking and providing the call number to call controller 111 (item 3). Call controller 111 uses the call number to dial the voice-handling media device via network 102a or network 102b. While connected with a voice media device (e.g., 103b, 103c or a media device 103a portion), call controller 111 requests a correspondence availability indicator (items 4a-4b). As with the FIG. 2a embodiment, the correspondence availability indicator is preferably provided by user 104, for example, directly or in response to an IVR. The indicator may, however, also be provided by the voice media device or by another system 200b component, for example, via a Bluetooth or other wired/wireless connection between the media devices.

In another embodiment, correspondence manager 110 compares the correspondence availability indicator with a stored set of allowable correspondence indicators, accepting the indicator if it is consistent with an allowable indicator and rejecting the indicator if it is inconsistent with the allowable indicators. In a further embodiment, correspondence manager 110 stores the indicator for use in establishing a correspondence relating to the now determined correspondence availability, or transfers the call number to a system 200b component that may provide for correspondence during a media session. A still further embodiment stores or transfers the call number in conjunction with establishing a correspondence or media device identity, for example, as given below. Other embodiments will also become apparent in view of the discussion herein.

Call controller 111 responds to the correspondence availability indicator by comparing the indicator with those stored in routing table 210b. If the indicator corresponds to a stored indicator, then a correspondence is established and call controller at least temporarily stores the dialed number of the voice-handling media device in routing table 201b. Otherwise, call controller 111 rejects the attempt to establish correspondence. Call controller 111 may further provide a voice or other notification of the same to the calling media device or other system 200a devices as with operation embodiment 200a.

As with the embodiment of FIG. 2a, call controller 111 may further identify the media devices, and may associate the stored IP address or other media device identifier of non-voice media handling media device 103a with the media device identity of the voice media handling media device, thereby establishing a correspondence. Alternatively or in conjunction therewith, such identity may also be transferred to correspondence manager or other system 200b component(s) for conducting such associating.

It will become apparent that the reusable indicator embodiment of FIG. 2b may be preferable over the FIG. 2a embodiment in a particular implementation. For example, the reusable indicator embodiment does not require creating or blocking of dialing patterns in a telephone system. Additionally, coordinating of the voice routing table with the non-voice availability may be avoided. The FIG. 2b embodiment may also provide for using two levels of checking that may be exploited by a corresponding media application, i.e. a phone number and identifier, among other considerations.

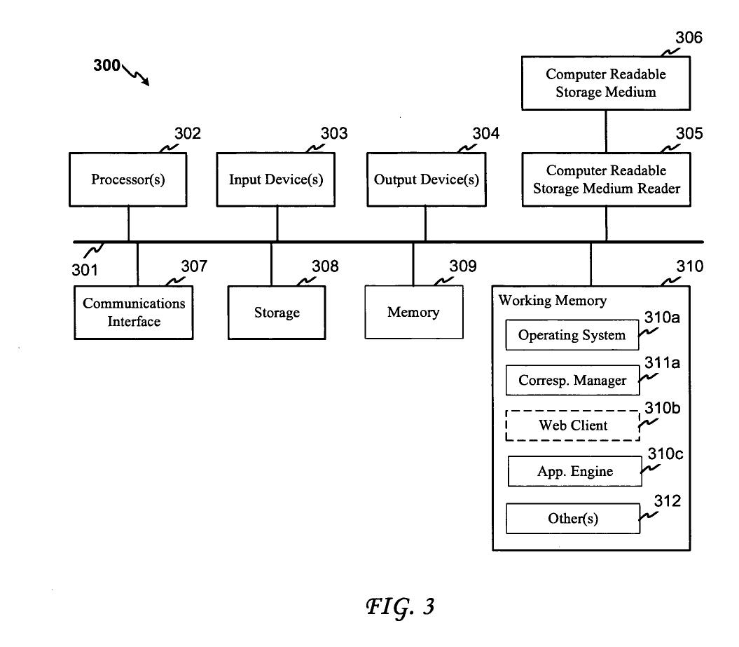

Turning now to FIG. 3, an exemplary computing system is illustrated that may comprise one or more of the components of FIG. 1. While other alternatives might be utilized, it will be presumed for clarity sake that components of the systems of FIG. 1 and elsewhere herein are implemented in hardware, software or some combination by one or more computing systems consistent therewith, unless otherwise indicated.

Computing system 300 comprises components coupled via one or more communication channels (e.g. bus 301) including one or more general or special purpose processors 302, such as a Pentium®, Centrino®, Power PC®, digital signal processor (“DSP”), and so on. System 300 elements also include one or more input devices 303 (such as a mouse, keyboard, microphone, pen, and so on), and one or more output devices 304, such as a suitable display, speakers, actuators, and so on, in accordance with a particular application.

System 300 also includes a computer readable storage media reader 305 coupled to a computer readable storage medium 306, such as a storage/memory device or hard or removable storage/memory media; such devices or media are further indicated separately as storage 308 and memory 309, which may include hard disk variants, floppy/compact disk variants, digital versatile disk (“DVD”) variants, smart cards, partially or fully hardened removable media, read-only memory, random access memory, cache memory, and so on, in accordance with the requirements of a particular implementation. One or more suitable communication interfaces 307 may also be included, such as a modem, DSL, infrared, RF or other suitable transceiver, and so on for providing inter-device communication directly or via one or more suitable private or public networks or other components that can include but are not limited to those already discussed.

Working memory 310 further includes operating system (“OS”) 311 components service host based correspondence system components including correspondence manager 310a and application link engine 311a or media device based browser or other Web client 310b, and other programs 312. Working memory components may also include one or more of application programs, mobile code, data, and so on for implementing system 100 components that might be stored or loaded therein during use. The particular OS may vary in accordance with a particular device, features or other aspects in accordance with a particular application (e.g., using Windows, WindowsCE, Mac, Linux, Unix or Palm OS variants, a cellular phone OS, IOS or some other proprietary OS, and so on). Various programming languages or other tools can also be utilized, such as those compatible with C variants (e.g., C++, C#), the Java 2 Platform, Enterprise Edition (“J2EE”) or other programming languages in accordance with the requirements of a particular application. Such working memory components can, for example, include one or more of applications, add-ons, applets, custom software and so on for conducting but not limited to the examples discussed elsewhere herein. Other programs 312 may, for example, include one or more of security, compression, synchronization, backup systems, groupware code, and so on, including but not limited to those discussed elsewhere herein.

When implemented in software (e.g. as an application program, object, agent, downloadable, servlet, and so on in whole or part), a document system or other component may be communicated transitionally or more persistently from local or remote storage to memory (SRAM, cache memory, etc.) for execution, or another suitable mechanism can be utilized, and elements can be implemented in compiled or interpretive form. Input, intermediate or resulting data or functional elements may further reside more transitionally or more persistently in a storage media, cache or other volatile or non-volatile memory, (e.g., storage device 308 or memory 309) in accordance with a particular application.

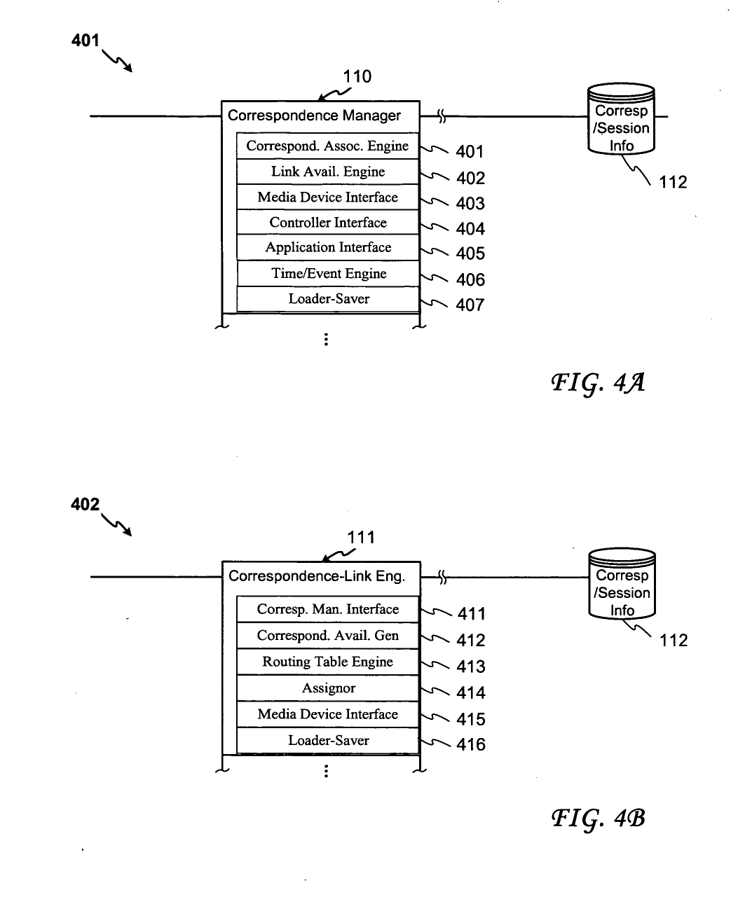

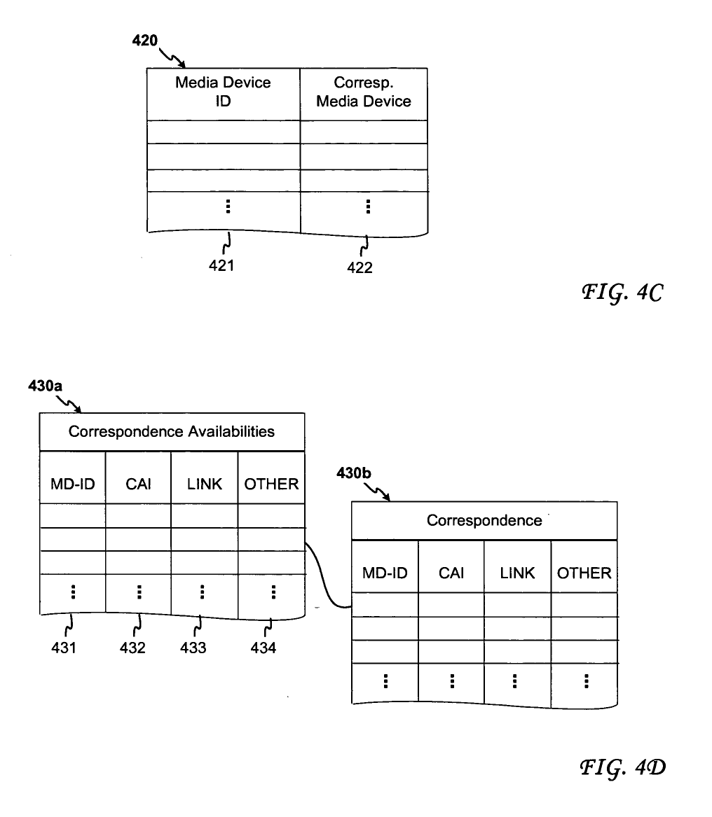

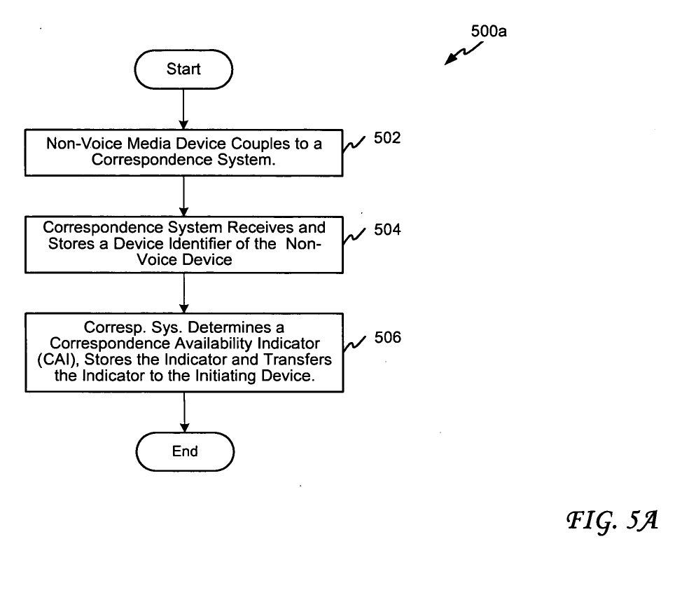

Referring now to FIG. 4a, there is seen a schematic diagram illustrating, in greater detail, an embodiment of correspondence manager 110 of FIG. 1 according to the invention. Correspondence manager 110 includes correspondence association engine (association engine) 401, link availability engine 402, media device interface 403, controller interface 404, application interface 405, time/event engine 406 and loader-saver 407.

Association engine 401 provides for conducting further management of correspondences during a media session. In such an embodiment, association manager 401 provides for storing correspondences of non-voice media handling and voice media device handling media devices, and for thereafter directing received media to a media device or media controller.

Link availability engine 402 provides for responding to media device correspondence coupling by initiating correspondence availability operations. Link availability engine 402, for example, provides for storing a media device identifier and invoking call controller 111 in the per request embodiment of FIG. 2a and for storing a media device identifier, receiving an availability indicator and invoking call controller 111 in the embodiment of FIG. 2b.

Media device interface 403 is responds to link availability engine 402 by conducting the media device presenting and input receiving, for example, via an encrypted Web page or media device transfer. Media device interface 403 also provides, in embodiments conducting media session related operations, for responding to association engine 402 by directing received media to a media device.

Of the remaining illustrated correspondence manager components, controller interface 404 provides for responding to link availability engine 402 by invoking call controller 111 and for responding to association engine 402 by directing media to call controller 111. Application interface 405 provides, in embodiments supporting remote correspondence management during a media session, for transferring correspondence information to other service host or other system 100 components. Application interface 405 also provides for receiving time/event criteria or media from a media session application and invoking association engine 402 for conducting further processing of the received information. Time/event engine 406 provides for determining time/event criteria for enabling, disabling or destroying correspondences or correspondence availabilities, and further, for processing time/event information from a media session application in conjunction with association engine operation (e.g., determining a response to such information). Loader-saver 407 provides for responding to other correspondence manager components by conducting related correspondence manager storage and retrieval operations.

FIG. 4b further illustrates a correspondence-link engine according to an embodiment of the invention. As shown, correspondence-link engine 402 includes correspondence manager interface 411 correspondence availability indicator generator 412, routing table engine 413, assignor 414, media device interface 415 and loader-saver 416.

Correspondence manager interface 411 provides for transferring to/from correspondence manager 410 correspondence information, such as a generated or received correspondence availability. Correspondence availability indicator generator (correspondence generator 412 provides for determining correspondence availability indicators. The indicators may, for example, be generated as call numbers, non-repeating random numbers, predetermined number sets corresponding to different users, user types, media device types, and so on, series of numbers (e.g., for enabling correspondences of multiple media devices), and so on or some combination thereof, in accordance with the requirements of a particular application. Routing table engine 413 provides for conducting storing, retrieving and comparing operations in conjunction with one or more routing tables. Assignor 414 provides for associating a generated or predetermined correspondence availability with a media device, media device link and so on. Media device interface 415 is operable for providing IVR, web page or other transfer of information with a phone or other media device via a corresponding network or other media device link. Loader-saver 416 provides for conducting related correspondence manager storage and retrieval operations.

FIGS. 4c and 4d illustrate examples of correspondence tables that may be maintained by a correspondence system and utilized in conjunction with media routing performed by the correspondence system or another correspondence enabled network system component during a media session. Beginning with FIG. 4c, correspondence table 420 may, for example, be utilized by a correspondence manager that is operable responsive to a media application for conducting non-voice media device routing and invoking a call controller for conducting voice media routing. As shown, correspondence table 420 provides for a correspondence of only two (or some other fixed number of) media devices and provides only minimal information. The information for each correspondence/availability may include, in the present example, a media device identifier 420 of a media device for which a correspondence availability has been determined, which is presumed to be a non-voice media device, and a related voice media device identifier if a correspondence with the first device has been established.

Contrastingly, correspondence tables 430a and 430b of FIG. 4d provide for storing additional information in conjunction with correspondence availabilities and correspondences of one or more other devices for which a related correspondence may be established. Correspondence tables 430a and 430b further provide for variable media device/media types and for variable interfacing, correspondence management criteria or other factors. In the illustrated example, correspondence availabilities table 430 and correspondence table both provide for a media device identifier 431, an associated correspondence availability indicator 432, link or routing information 433 and other information. Other information may, for example, include a particular device type, device interface, owner/user, location, criteria for rendering a correspondence/availability active or inactive in conjunction with a time/event condition, destroying or otherwise modifying a correspondence/availability, and so on (e.g., see FIGS. 4a-b). While the additional information provided by tables 430a-b may be useful in conjunction with fixed-configuration correspondence system routing during a media session, the information and flexibility may be particularly useful in conjunction with a reconfigurable correspondence system or where media session routing is conducted by other than the correspondence system. It will be appreciated, however, that the particular information maintained and the specific manner for doing so may vary considerably in accordance with the requirements of a particular application.

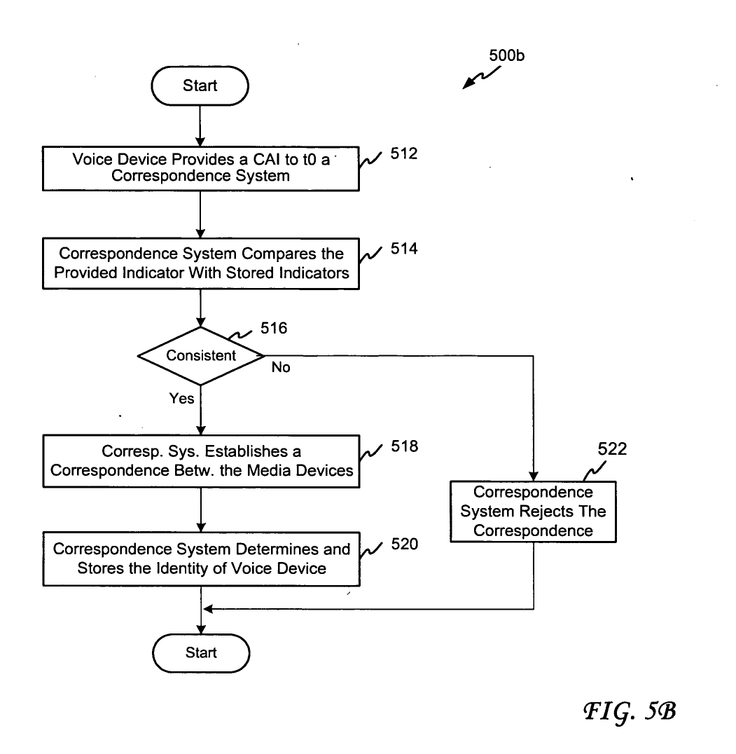

The FIGS. 5a and 5b flowcharts respectively illustrate a media device correspondence availability method and a media device correspondence establishing method according to an embodiment of the invention. The illustrated methods provide for determining such correspondence in accordance with a variable or per request correspondence availability identifier, and may further be utilized in conjunction with one another for providing media device correspondence. The methods may, for example, be performed by a correspondence system implementing separate or integrated components that include a correspondence manager and a call controller.

Beginning with FIG. 5a, the correspondence availability method includes, in block 502, a non-voice media device coupling to a correspondence system. The non-voice or correspondence availability “initiating” media device may, for example, couple by initiating an encrypted Web page or using another suitable mechanism. In block, 504, the correspondence system determines a device identifier of the initiating media device, for example, by receiving and storing an IP address of a received IP packet. In block 504, the correspondence system determines a correspondence availability indicator (CAI). The correspondence system further at least temporarily stores the CAI and transfers the CAI to the initiating media device.

Continuing with FIG. 5b, the illustrated method for establishing a correspondence relating to a correspondence availability includes, in block 512, a correspondence system receiving a CAI from a voice media device, for example, via a call from the voice media device or using another suitable mechanism. In block 514, the correspondence system compares the provided CAI with a set of stored CAIs, for example, in a CAI list. If, in block 516, the received CAI is consistent with (e.g., matches) a stored CAI relating to a non-voice media device, then the correspondence system establishes a correspondence between the non-voice media device and the voice media device.

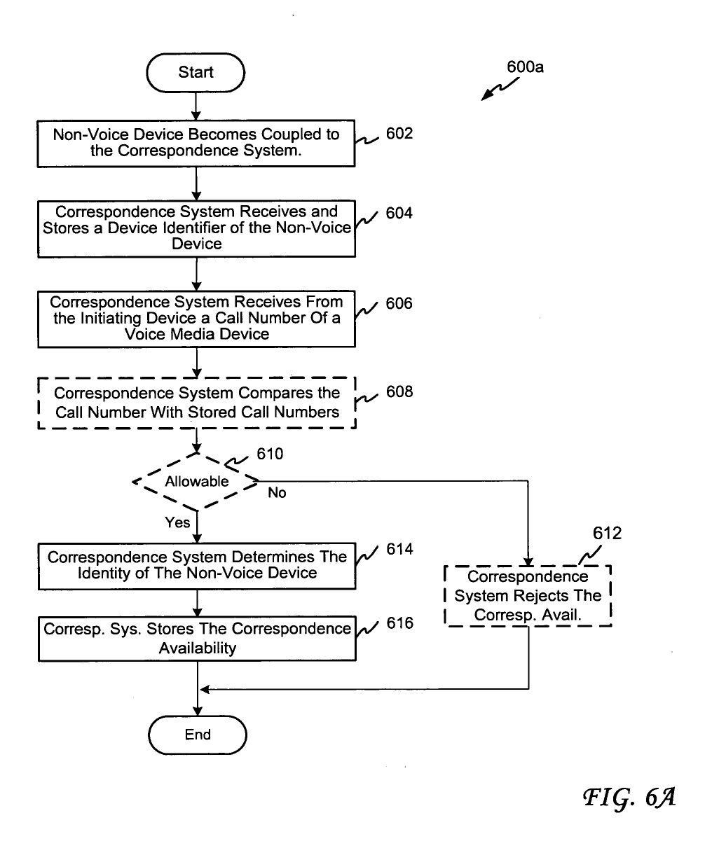

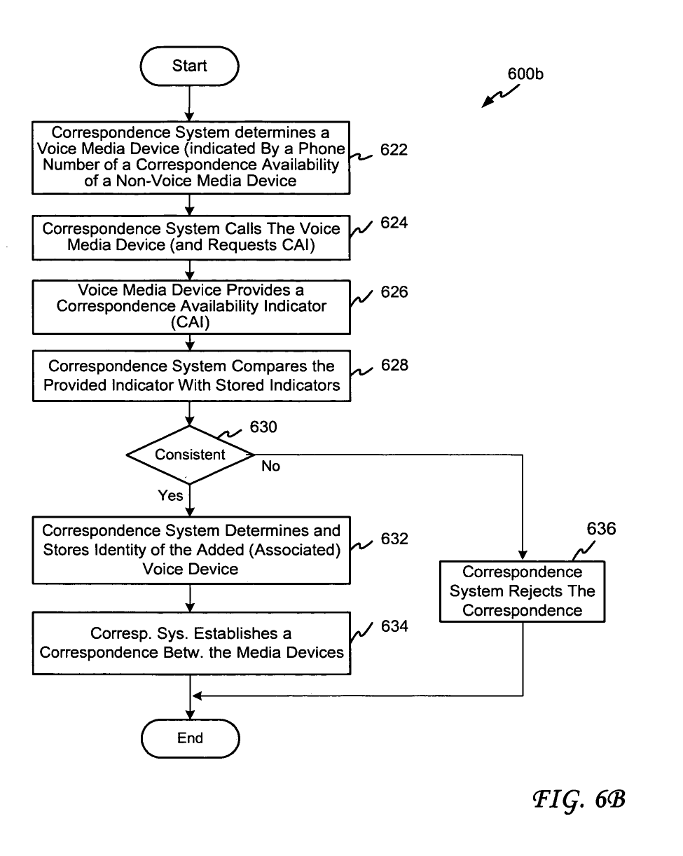

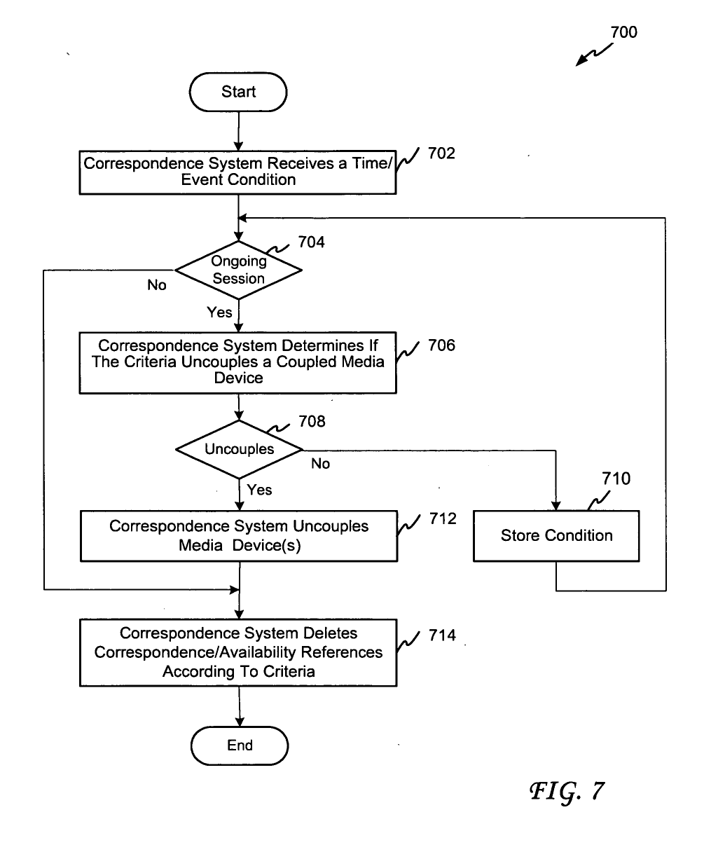

FIGS. 6a and 6b respectively illustrate a media device correspondence availability method and a media device correspondence establishing method using a fixed or reusable correspondence availability indicator, according to embodiments of the invention. As with methods 500a and 500b of FIGS. 5a and 5b, methods 600a and 600b may be utilized in conjunction with one another for providing media device correspondence. The methods may also be performed by a correspondence system implementing separate or integrated components that include a correspondence manager and a call controller.

As shown in FIG. 6a, in block 602, a non-voice media device couples to a correspondence system. In block 604, the correspondence system receives from the non-voice media device a device identifier of the initiating media device (e.g., included in a received non-voice media device data packet). In block 606, the correspondence system receives from the voice media device a call number of a voice media device, and in blocks 608 through 612, the correspondence system provides for optionally implementing a call number verification.

The call number verification provides a mechanism that, for example, enables a controlling application or application or correspondence system provider to limit media access, easedropping and so on by including or excluding certain users, media devices or media device localizations (e.g., a cellular other wireless or personal phone, or an IP or other communication device of a particular person). It will be appreciated that one or more of the methods 500a-b and 600a-b may also provide for conducting security in conjunction with a non-voice media device or selectively of non-voice and voice media devices. Where call verification is performed, the correspondence system compares the call number with stored call numbers in block 608, and if the call number is not allowable in block 610, the correspondence system rejects the call number in block 612 and the method ends. (The stored call numbers may, for example, include call numbers to include, call numbers to exclude, other criteria or some combination.)

Where call verification is not performed or a call number is found to be allowable in block 610, the method continues with block 614. In block 614, the correspondence system determines the identity of the non-voice device, and in block 616, the correspondence system stores the correspondence availability.

Continuing now with the media device correspondence establishing method of FIG. 6b, in block 622, a correspondence system determines a voice media device indicated by a call number of a correspondence availability relating to a non-voice media device. The call number may, for example, have been temporarily stored in a call controller routing list according to method 600a of FIG. 6a. In block 624, the correspondence system calls the voice media device. The correspondence system further requests, from the voice media device or a user thereof, a correspondence availability indicator (CAI). The CAI may, for example, include a user or media device identifier. In block 626, the CAI is provided via the voice media device, for example, using a CAI stored by the device, input by a device user or input by a coupled non-voice media device. In block 628, the correspondence system compares the provided CAI with CAIs stored by the correspondence system. If, in block 630, the provided CAI correspondence with (e.g., matches) a stored CAI, then the correspondence system determines and stores a specific identity of the added (or “associated”) voice device in block 632 and establishes and stores a correspondence between the non-voice and voice media devices. (As with method 600b of FIG. 6b, the correspondence system may store the correspondence locally, transfer the correspondence to at least one different device for storage or some combination, in accordance with the requirements of a particular application.)

FIG. 7 illustrates a method for destroying a correspondence availability or correspondence according to an embodiment of the invention. The illustrated example shows how embodiments of the present invention may provide for media device correspondence that is substantially independent of a particular media device coupling or media session, and how a correspondence availability may also persist substantially independently of a currently existing correspondence. The illustrated embodiment also shows one example of how a finer or coarser granularity of control may be exploited in accordance with a particular embodiment.

In block 702, a correspondence system determines that a correspondence destroying time/event condition has occurred. Time/event conditions may, for example, include the correspondence system receiving a user or media application indicator indicating that a correspondence or correspondence availability is to be destroyed (e.g., via the above-noted Web page or other suitable mechanism), that a media device interruption or other error may have occurred, that a particular time period has expired, and so on (e.g., see above). The correspondence system may determine such occurrence independently, in conjunction with receiving an indicator or some combination.

In block 704, the correspondence system determines whether a media session employing an associated media device is ongoing. If so, then the method proceeds with block 706; if not, then the method proceeds with block 714.

In block 706, the correspondence system determines if the criteria should cause a media device that is coupled for an ongoing media session to become uncoupled. If not (block 708), the correspondence system stores the condition in block 708 and returns to block 704; otherwise the correspondence system uncouples the corresponding media device(s) in block 710. In block 710, the correspondence system deletes the correspondence information (e.g., see FIGS. 4c-d) or further deletes the correspondence association information relating to the current correspondence of media devices. (It will become apparent that a correspondence availability may persist for at least one device even after deleting correspondence information.)

It should be noted that method 700 may also be conducted by the correspondence system, a correspondence enabled system component other than the correspondence system (e.g., to which the correspondence system has provided a correspondence), or some combination, in accordance with requirements of a particular application.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method performed by a media device correspondence system, comprising:
receiving a media-device coupling of a first media device;
determining at least one determined correspondence availability indicator with which a correspondence may be established with a second media device without requiring a direct connection between the first and a second media device; and
providing at least one correspondence availability indicator to the first media device, thereby determining a media device correspondence availability.

2. A method according to claim 1, wherein the first media device includes a non-voice media device and the second media device includes a voice media device.

3. A method according to claim 1, wherein the media-device coupling provides a first media device identifier and further comprising storing the first media device identifier.

4. A method according to claim 1, wherein the media-device coupling includes the first media device initiating an encrypted Web page.

5. A method according to claim 1, wherein the determining comprises at least one of retrieving a stored correspondence availability indicator and calculating a correspondence availability indicator.

6. A method according to claim 1, wherein:
the providing is conducted prior to the receiving the media-device coupling of the first media device; and
the determining includes receiving, from the first media device, a second media device identifier for identifying the second media device.

7. A method according to claim 6, wherein the second device identifier includes a phone number corresponding to the second media device.

8. A method according to claim 6, further comprising determining whether the second device identifier identifies an allowable second media device.

9. A method according to claim 1, further comprising:
causing a communication link to the second media device;
receiving, from the second media device, a received correspondence availability indicator; and
verifying that the received correspondence availability indicator is consistent with a determined correspondence availability indicator, and if so, establishing a correspondence between the first and second media devices.

10. A method according to claim 9, wherein the communication link to the second media device is caused to occur via an IP network

11. A method according to claim 9, wherein the communication link to the second media device is caused to occur via PSTN.

12. A method according to claim 9, wherein the causing a communication link to the second media device comprises receiving a call from the second media device.

13. A method according to claim 9, wherein the causing a communication link to the second media device comprises the correspondence system calling the second media device.

14. A machine-readable medium having stored thereon instructions for causing a correspondence system to perform the steps of:
receiving a media device communication link of a first media device;
determining at least one determined correspondence availability indicator with which a correspondence may be established with a second media device without requiring a direct connection between the first and a second media device; and
providing a correspondence availability indicator to the first media device, thereby determining a media device correspondence availability.

15. A correspondence system, comprising:
means for receiving a media device communication link of a first media device;
means for determining at least one determined correspondence availability indicator with which a correspondence may be established with a second media device without requiring a direct connection between the first and a second media device; and
means for providing a correspondence availability indicator to the first media device, thereby determining a media device correspondence availability.

16. A delay management apparatus, comprising:
a network interface that is coupled a data network for receiving one or more packet flows therefrom;
a processor; and
one or more stored sequences of instructions which, when executed by the processor, cause the processor to carry out the steps of:
receiving a media device communication link of a first media device;
determining at least one determined correspondence availability indicator with which a correspondence may be established with a second media device without requiring a direct connection between the first and a second media device; and
providing a correspondence availability indicator to the first media device, thereby determining a media device correspondence availability.

17. A delay management apparatus according to claim 16, wherein the first media device includes a non-voice media device and the second media device includes a voice media device.

18. A delay management apparatus according to claim 16, wherein the first device coupling provides a first media device identifier and further comprising storing the first media device identifier.

19. A delay management apparatus according to claim 16, wherein the first media device coupling includes the first media device initiating an encrypted Web page.

20. A delay management apparatus according to claim 16, wherein the determining comprises at least one of retrieving a stored correspondence availability indicator and calculating a correspondence availability indicator.
